(19) United States
(12) Patent Application Publication
(10) Pub. No.: US 2002/0081163 A1
(43) Pub. Date: Jun. 27, 2002

(54) Stroking speed adjustment for shaping machine

(76) Inventor: Joseph A. Courtney, Rochester, NY (US)

Correspondence Address: THE GLEASON WORKS, 1000 UNIVERSITY AVENUE, P O BOX 22970, ROCHESTER, NY, 146922970

(21) Appl. No.: 10/014,672

(22) Filed: Dec. 11, 2001

Related U.S. Application Data
(60) Provisional application No. 60/257,815, filed on Dec. 21, 2000.

(51) Int. Cl. B26D 1/12

(52) U.S. Cl. 407/30

(57) ABSTRACT

A stroking speed adjustment for a computer controlled shaping machine for forming at least one tooth on a workpiece with a cutting tool, the cutting tool being reciprocated to define a tool stroking motion wherein the tool stroking comprises a cutting stroke and a return stroke, and wherein the return stroke is carried out at a speed faster than the speed of the cutting stroke. The machine comprises a rotatable element, such as a drive shaft, associated with the reciprocation of the cutting tool. The rotatable element includes at lease one detectable surface positioned thereabout and a position sensor is placed adjacent said shaft and detectable surface. During rotation of the element, the passing of the leading edge of the detectable surface proximate the position sensor at the beginning of the return stroke results in a signal being sent to the computer to effect an increase in the speed of the return stroke relative to the speed of the cutting stroke, and wherein passing of the trailing edge of the detectable surface proximate the position sensor at the beginning of the cutting stroke results in a signal being sent to the computer to effect a return to the speed of the cutting stroke.

This application claims the benefit of U.S. Provisional Application No. 60/257,815 filed Dec,21, 2000.

### FIELD OF THE INVENTION

The present invention is directed to gear shaping machines and in particular to a method of controlling the stroking of a shaping tool during the gear shaping process.

### BACKGROUND OF THE INVENTION

In a conventional gear shaping process for producing spur gears, a cutting tool is reciprocated upwardly and downwardly past the periphery of a gear blank. As the cutting tool is passed downwardly through an active cutting stroke, the teeth of the cutting tool engage the periphery of the gear blank to form gear teeth thereon. The cutting tool is then moved radially away from, and out of engagement with, the gear blank (referred to as “backing-off”) in order to provide clearance or relief between the cutting tool teeth and the newly formed gear teeth in preparation for the cutting tool being passed upwardly past the gear blank through an inactive return stroke.

As the cutting tool is reciprocated, the gear blank is rotated about the axis of the work spindle and the cutting tool is rotated in an opposite direction about the axis of the cutter spindle in order to generate gear teeth around the periphery of the blank. The rotations of tool and gear blank being in accordance with the ratio of the number of desired teeth in the gear divided by the number of blades in the cutting tool. During reciprocation and rotation of the cutting tool and rotation of the gear blank, relative infeeding of the cutting tool and the gear blank is effected in order to gradually increase the depth of cut of the cutting tool into the blank.

Of course, it is understood by the artisan that the formation of internal teeth on a workpiece requires rotations of the workpiece and tool to be in the same direction. Furthermore, formation of helical gear teeth requires an additional rotation of the cutting tool, or workpiece, during the cutting (down) stroke as the cutting tool moves through the workpiece.

In an attempt to economize the gear shaping process, it has been proposed to increase the speed of the return stroke of the cutting tool thereby reducing the total stroke cycle time and hence, increasing the productivity of the gear shaping machine. One such method of increasing the speed of the return stroke is disclosed in U.S. Pat. No. 4,136,302to Tlaker et al. which teaches a stroking spindle driven by hydraulic fluid wherein potentiometers are utilized to add voltage signals to the basic stroking speed signal to effect an increase in hydraulic fluid pressure during the return stroke thereby causing an increase in speed of the return stroke.

Another known method for increasing the speed of a return stroke comprises programming the machine controller to vary the rotational speed of the drive shaft connected to a stroking mechanism by inputting commands whereby rotational speeds are varied between predetermined degree intervals of drive shaft rotation. For example, in that degree interval portion of drive shaft rotation (e.g. 180-360degrees) which propels the return stroke, the rotational speed of the drive shaft would be increased thus increasing the speed of the return stroke, thereby reducing cycle time.

### SUMMARY OF THE INVENTION

The present invention comprises a computer controlled machine for forming at least one tooth on a workpiece with a cutting tool, the cutting tool being reciprocated to define a tool stroking motion wherein the tool stroking comprises a cutting stroke and a return stroke. The return stroke is carried out at a speed faster than the speed of the cutting stroke.

The machine comprises a rotatable element, such as a drive shaft, associated with the reciprocation of said cutting tool. In one embodiment, the element includes a detectable surface positioned thereabout with a position sensor located adjacent the shaft and detectable surface. During rotation of the element, the passing of the leading edge of the detectable surface proximate the position sensor at the beginning of the return stroke results in a signal being sent to the computer to effect an increase in the speed of the return stroke relative to the speed of the cutting stroke. Passing of the trailing edge of the detectable surface proximate the position sensor at the beginning of said cutting stroke results in a signal being sent to the computer to effect a return to the speed of the cutting stroke.

### BRIEF DESCRIPTION OF THE DRAWINGS

FIG. 1 schematically illustrates a known type of gear shaping machine.

FIG. 2 is an enlargement of the shaping head of FIG. 1.

FIG. 3 illustrates drive systems for effecting the stroking and backing-off movements of the shaping tool.

FIG. 4 illustrates one embodiment of the invention wherein a detectable surface and a position sensor are placed about a rotating machine element.

FIG. 5 illustrates another embodiment of the present invention wherein a plurality of detectable surfaces and a position sensor are placed about a rotating machine element.

### DETAILED DESCRIPTION OF THE PREFERRED EMBODIMENT

The present invention will now be discussed with reference to the accompanying drawings.

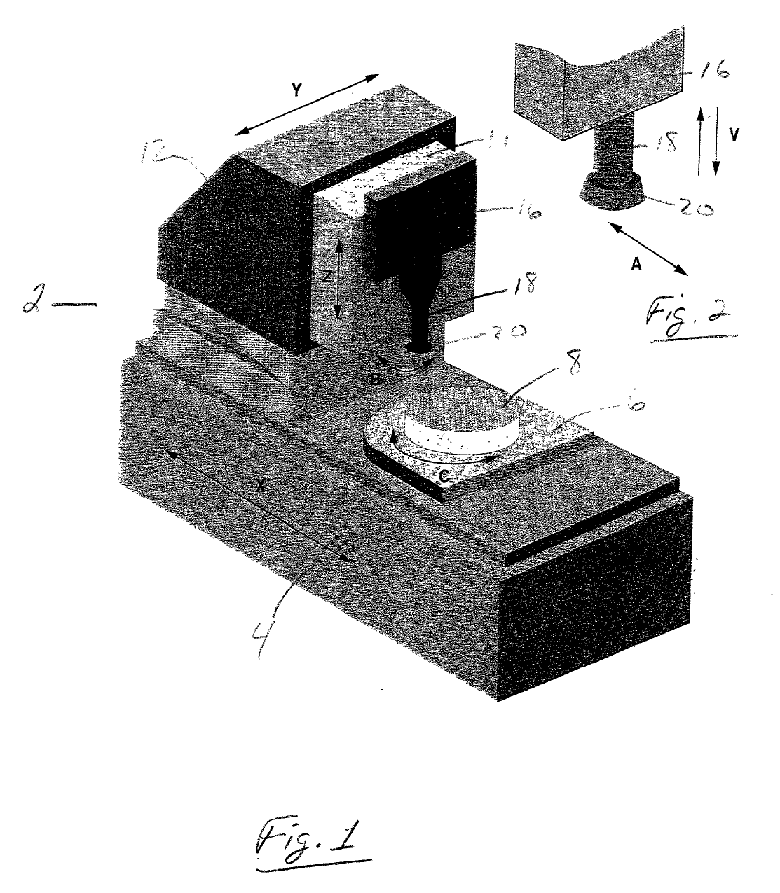

FIG. 1 illustrates a known type of gear shaping machine 2 comprising a machine base 4, worktable 6 and workpiece 8 rotatable about an axis C. The workpiece 8 is releasably secured on worktable 6 by a suitable workholding apparatus 1 0 (FIG. 3) as would be known by the artisan.

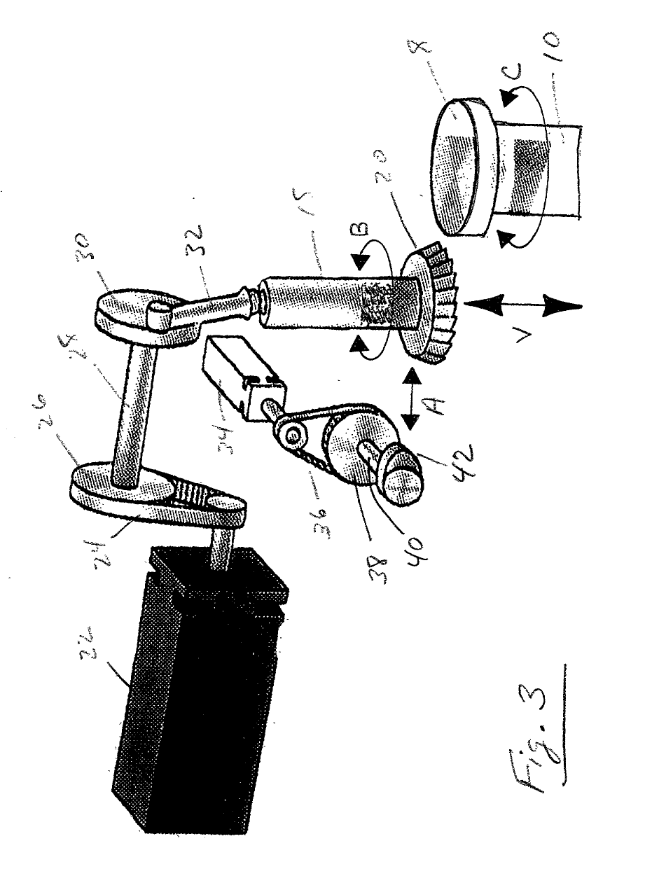

Also located on base 4 is tool column 12 which is movable in a direction X along the length of machine base 4 as well as in a direction Y along the width of the machine base 4. Tool slide 14, movable in a vertical direction Z, is attached to column 12 and tool head 16 is secured to tool slide 14. A rotatable tool spindle 18 is positioned in tool head 16 and a shaping tool 20 is mounted to the distal end of spindle 18 by any suitable tool holding mechanism as would be known by the artisan. Tool spindle 18, and hence shaping tool 20, is rotatable around a tool axis B (FIG. 3) by a servomotor (not shown) and is reciprocated (stroked) as illustrated by directional arrows V (FIG. 2). The downward direction being the cutting stroke and the upward direction being the return stroke.

The stroking of tool spindle 18 and shaping tool 20 is effected by the drive system illustrated in FIG. 3. Servomotor 22, via belt 24 and pulley 26, drives shaft 28 which is connected to crank 30. Arm 32 connects crank 30 to tool spindle 18. Arm 32 is radially positionable (either manually or by computer control) on crank 30 in order to control the stroke length of the shaping tool 20. Alternatively, motor 22 may directly drive shaft 28.

As previously discussed, at the conclusion of a downward (cutting) stroke, the tool 20 is “backed-off (i.e. moved away) from the workpiece in order to provide clearance or relief between the teeth of the cutting tool and the teeth of the newly formed gear preparation for the cutting tool being passed upwardly past the workpiece through the inactive return stroke. Backing-off is illustrated by direction A in FIGS. 1 and 3. The backing-off may be accomplished through the use of a back-off cam 42 rotatable by servomotor 34 via belt 36, pulley 38 and shaft 40 as is shown in FIG. 3.

Since backing-off commences at the conclusion of the cutting stroke, it is believed clearly understandable that a timed relationship exists between the tool stroking and backing-off of the tool from the workpiece in order for the backing-off to commence at the conclusion of the cutting stroke and end a point where the tool has passed the workpiece during the return stroke but prior to the beginning of the next cutting stroke.

The timed relationship (i.e. the coordination) between the rotation of the back-off cam 42 and the stroking of the spindle 18, as well as the rotations of the shaping tool 20 and workpiece 8 in order to form a geometrically correct toothed workpiece are all synchronized by an electronic gearbox (EGB) as part of the computer numerical control (CNC) of the gear shaping machine. Examples of machine controllers being Fanuc 160i or Siemens 840C. Additionally, movement of tool column 12 in the X direction, movement of tool slide 14 in the Z direction and, optionally, the length of stroking in direction V are also controlled by the machine controller although stroke length may be a manual adjustment. Usually, positioning of tool column in the Y direction is a manual adjustment although it may also be under the control of the machine controller.

As stated above, it is known to increase the speed of the return stroke so as to economize the gear shaping process. Increasing the speed of the return stroke of the cutting tool reduces the total stroke cycle time and hence, increases the productivity of the gear shaping machine. By reducing the return stroke time, the feedrate for the radial infeed motion (X direction) can be increased allowing faster cycle times with the same metal removal rate per stroke. The present invention provides a simplified means to effect the increased speed of the return stroke.

The present invention comprises placing at least one detectable surface, preferably a single detectable surface, at a desired location about one of the drive shafts associated with reciprocation of the cutting tool and placing a position sensor adjacent the shaft and the detectable surface. During rotation of the shaft, the passing of the leading edge of the detectable surface proximate the position sensor at the beginning of the return stroke results in a signal being sent to the computer control to effect an increase in the speed of the return stroke relative to the speed of the cutting stroke, and wherein passing of the trailing edge of the detectable surface proximate the position sensor at the end of the return stroke or the beginning of the cutting stroke results in a signal being sent to the computer control to effect a return to the desired speed of the cutting stroke.

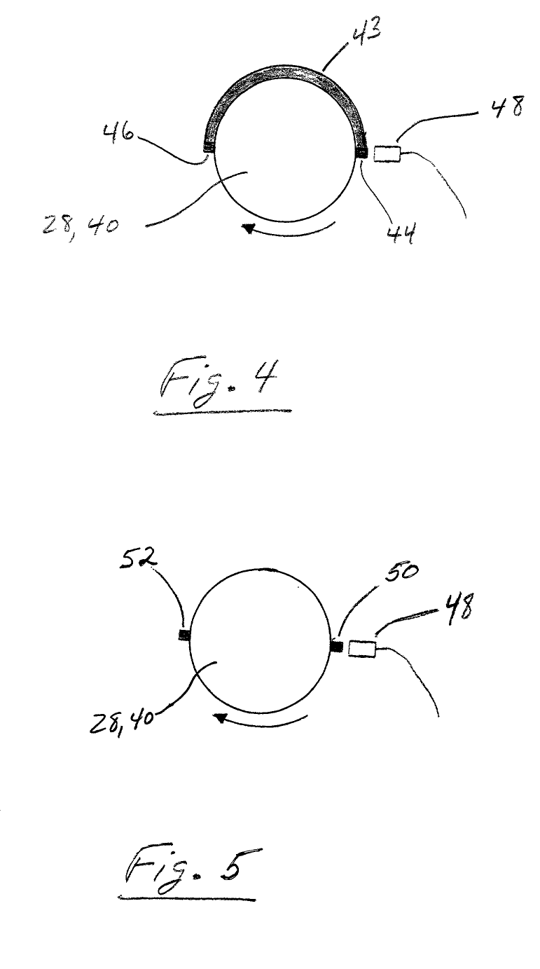

FIG. 4 illustrates the preferred embodiment of the present invention wherein placement of detectable surfaces 43 positioned about the periphery of one of the drive shafts 28 or 40 associated with reciprocation (stroking) of the cutting tool 20. A position sensor 36, such as a non-contact proximity sensor, is positioned adjacent the shaft 28 or 40 and the detectable surfaces 43 such that as the leading edge 44 of the detectable surface 43 passes position sensor 48, a signal is sent to the machine controller to trigger a programmed increase the rotational speed of the shaft by an amount to effect an increase in the speed of the return stroke to a predetermined speed greater than the speed of the cutting stroke. The shaft 28 or 40 then rotates at the increased speed until the trailing edge 46 of the detectable surface 43 passes position sensor 48 and a signal is sent to the machine controller to trigger a programmed decrease in the rotational speed of the shaft to that required to effect a return to the desired speed of the cutting stroke.

It is to be understood that the placement and extent of the detectable surface 43 about shaft 28 or 40 is dependent upon the placement of the sensor 48 and the rotational position of either shaft with respect to the beginning and/or end, of the cutting and return strokes. In other words, detectable surface 43 should be placed on shaft 28, for example, such that the leading edge 44 is adjacent position sensor 48 at the beginning of the return stroke so that the increase in return stroke speed can be realized as quickly as possible with respect to the beginning of the return stroke. Likewise, placement of the detectable surface 43 on shaft 28 should be such that the trailing edge 46 is adjacent position sensor 48 at the beginning of the cutting stroke so that the proper cutting stroke speed can be attained prior to the tool contacting the workpiece. Usually, detectable surface 43 will extend generally 180 degrees about the particular drive shaft A detectable surface may comprise a surface of any configuration that is set apart or raised with respect to the surface of the rotating element by an amount sufficient to trigger the position sensor 48.

Although the present invention has been discussed with respect to placing detectable surface43 on tool spindle drive shaft 28, which is preferred, or on back-off cam drive shaft 40, the invention also contemplates placement of a detectable surface on any other shaft or other rotated object whose rotation is associated with the stroking of the cutting tool 20. For example, a detectable surface may be placed about the crank 30 or spindle 18.

An alternative embodiment is shown in FIG. 5 wherein two detectable surfaces 50, 52 are utilized on a rotatable surface. One detectable surface, for example 50, triggers an increase in the speed of the return stroke while another detectable surface, for example 52, triggers a return to the speed of the cutting stroke.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A computer controlled machine for forming at least one tooth on a workpiece with a cutting tool, said cutting tool being reciprocated to define a tool stroking motion wherein said tool stroking comprises a cutting stroke and a return stroke, and wherein said return stroke is carried out at a speed faster than the speed of said cutting stroke,
said machine comprising a rotatable element associated with the reciprocation of said cutting tool, said element including at least one detectable surface positioned thereabout,
a position sensor located adjacent said element and detectable surface,
whereby during rotation of said element, the passing of a leading edge of said at least one detectable surface proximate said position sensor at the beginning of said return stroke results in a signal being sent to the computer to effect an increase in the speed of the return stroke relative to the speed of said cutting stroke, and wherein passing of a trailing edge of said at least one detectable surface proximate said position sensor at the end of said return stroke or at the beginning of said cutting stroke results in a signal being sent to the computer to effect a return to the speed of the cutting stroke.

2. The machine of claim 1 wherein said detectable surface comprises a single surface having a leading edge and a trailing edge.

3. The machine of claim 1 comprising two detectable surfaces.

4. The machine of claim 1 wherein said rotatable element comprises a tool spindle drive shaft.

5. The machine of claim 1 wherein said rotatable element comprises a back-off cam drive shaft.

6. The machine of claim 1 wherein said rotatable element comprises a crank.

7. The machine of claim 1 wherein said rotatable element comprises a tool spindle.

8. The machine of claim 1 wherein said position sensor comprises a non-contact proximity sensor.

9. The machine of claim 1 wherein said at least one detectable surface extends generally 180 degrees about said rotatable element.

10. A computer controlled gear shaping machine for forming at least one tooth on a workpiece with a cutting tool, said cutting tool being reciprocated to define a tool stroking motion wherein said tool stroking comprises a cutting stroke and a return stroke, and wherein said return stroke is carried out at a speed faster than the speed of said cutting stroke,
said machine comprising a rotatable element associated with the reciprocation of said cutting tool, said element including a detectable surface positioned thereabout, said detectable surface comprising a leading edge and a trailing edge,
a position sensor located adjacent said element and detectable surface,
whereby during rotation of said element, the passing of said leading edge of said detectable surface proximate said position sensor at the beginning of said return stroke results in a signal being sent to the computer to effect an increase in the speed of the return stroke relative to the speed of said cutting stroke, and wherein passing of said trailing edge of said detectable surface proximate said position sensor at the end of said return stroke or at the beginning of said cutting stroke results in a signal being sent to the computer to effect a return to the speed of the cutting stroke.

11. The machine of claim 10 wherein said rotatable element comprises a tool spindle drive shaft.

12. The machine of claim 10 wherein said rotatable element comprises a back-off cam drive shaft.

13. The machine of claim 10 wherein said position sensor comprises a non-contact proximity sensor.

14. The machine of claim 10 wherein said at least one detectable surface extends generally 180 degrees about said rotatable element.

15. A method of forming toothed articles on a computer controlled machine with a reciprocating cutting tool, said reciprocating comprising a cutting stroke and a return stroke, said method including:
carrying out said return stroke at a speed greater than the speed of the cutting stroke, the greater speed of the return stroke being effected by,
selecting a rotatable machine element associated with the reciprocation of said cutting tool,
positioning a detectable surface about said machine element, said detectable surface comprising a leading edge and a trailing edge,
locating a position sensor adjacent said element and detectable surface,
passing said leading edge of said detectable surface proximate said position sensor at the beginning of said return stroke thereby resulting in a signal being sent to the computer to effect an increase in the speed of the return stroke relative to the speed of said cutting stroke, and,
passing of said trailing edge of said detectable surface proximate said position sensor at the end of said return stroke or at the beginning of said cutting stroke thereby resulting in a signal being sent to the computer to effect a return to the speed of the cutting stroke.
